(19) United States
(12) Patent Application Publication
(10) Pub. No.: US 2025/0135826 A1
(43) Pub. Date: May 1, 2025

(54) ROLLING DAMPER, RESPECTIVE SUSPENSION SYSTEM WITH ASYMMETRIC ROLLING MOVEMENT AND SYMMETRIC VERTICAL MOVEMENT, MOUNTING METHOD THEREOF

(71) Applicant: IRREVERENTDRAGON, LDA, Perafita (PT)

(72) Inventor: Diogo DA FONSECA ARAÚJO MATOS, Matosinhos (PT)

(73) Assignee: IRREVERENTDRAGON, LDA, Perafita (PT)

(21) Appl. No.: 18/692,164

(22) PCT Filed: Sep. 13, 2022
(86) PCT No.: PCT/IB2022/058620

§ 371 Date: Mar. 14, 2024

(30) Foreign Application Priority Data
Sep. 14, 2021 (PT) 117462
Nov. 15, 2021 (EP) 21208343.0

(51) Int. Cl. B60G 15/06; B60G 13/00; B60G 17/027; B60G 21/02; B60G 21/05

(52) U.S. Cl. CPC B60G 15/067; B60G 13/005; B60G 17/0272; B60G 21/026; B60G 21/05; B60G 2202/312; B60G 2204/13; B60G 2204/421; B60G 2204/422; B60G 2204/4232; B60G 2204/424; B60G 2204/82

(57) ABSTRACT

Roll damper assembly for a vehicle suspension, comprising: a first bracket comprising first inner and outer bracket; a second bracket comprising second inner and outer bracket; a roll damper mounted between first and second inner bracket; first mount coupled to first outer bracket and second mount coupled to second outer bracket; first guide rod attached at first end to first outer bracket, and slidably attached to inner second bracket; a second guide rod attached at a first end to second outer bracket, and slidably attached to inner first bracket; first end stopper mounted on the second end of said first guide rod to stop second end of said first guide rod from exiting from slidable attachment to inner second bracket; second end stopper mounted on second end of said second guide rod to stop second end of said second guide rod from exiting from slidable attachment to inner first bracket.

### TECHNICAL FIELD

The present disclosure relates to a rolling damper, respective suspension system that works with the rolling/asymmetric movement separately from the vertical/symmetrical movement of the car.

### BACKGROUND

EP1997655B1 discloses a suspension system that is to be installed in a vehicle, and more particularly to such a suspension system equipped with an electromagnetic actuator that functions as a shock absorber, useful for establishment of a suspension characteristic based on a so-called skyhook theory. EP1997655B1 discloses a spring-rate changing control.

US20200062067A1 discloses a method of on demand energy delivery to an active suspension system is disclosed. The suspension system includes an actuator body, a hydraulic pump, an electric motor, a plurality of sensors, an energy storage facility, and a controller. The method includes disposing an active suspension system in a vehicle between a wheel mount and a vehicle body, detecting a wheel event requiring control of the active suspension; and sourcing energy from the energy storage facility and delivering it to the electric motor in response to the wheel event.

Some of the sector's competitors but only with solutions/products in the traditional format: WO2011034702 discloses a hydraulic anti-roll system for a vehicle includes a first hydraulic actuator, a second hydraulic actuator, an anti-roll control module, and an anti-roll bypass valve. The first hydraulic actuator is adapted to be connected between the suspension and frame of the vehicle on one side and the second hydraulic actuator is adapted to be connected between the suspension and frame of the vehicle on its other side. The anti-roll control module is connected between the fluid lines of the first and second hydraulic actuators. The anti-roll control module stiffens the compression of the first hydraulic actuator relative to the expansion of the second hydraulic actuator, and stiffens the compression of the second hydraulic actuator relative to the expansion of the first hydraulic actuator. The anti-roll bypass valve is adapted to activate and deactivate the stiffening of the anti-roll control module.

US20040195796A1 discloses a decoupled anti-roll system. This solution with the same type of objective but with a much more complex installation using hydraulic connection and a clutch mounted to separate anti-roll bars.

US20040265169A1 discloses an inspection tester that can be used anywhere as a primary screening tool by non-technical personnel to determine whether a surface contains explosives.-Solution for a decoupled suspension that uses the principle of active suspension.

US20140116243A1 discloses a hydraulic actuator assembly includes an actuator, a first sink subsystem in fluid communication with an upper working chamber of the actuator, a second sink subsystem in fluid communication with a lower working chamber of the actuator and a source subsystem in fluid communication with both the upper and lower working chambers of the actuator. This solution for a decoupled suspension that uses the principle of active suspension.

These facts are disclosed in order to illustrate the technical problem addressed by the present disclosure.

### GENERAL DESCRIPTION

This disclosure proposes a suspension system that works with the rolling/asymmetric movement separately from the vertical/symmetrical movement of the car.

The idea and concept behind this disclosure is based on the fact that this is achieved only with two dampers in which one dampens the Vertical/Symmetrical movement and the other, through an innovative mechanical system, is able to absorb the asymmetric compression movement when the car tilts and expanding when the car returns to its normal position, both ways.

Based on this principle, a normally mounted damper always has a hysteresis between the movement in compression (bump) and expansion (rebound) and the force that results from that movement.

If a conventional shock absorber is fitted to control the rolling motion of the car (angle a) then we will have a difference in damping when the rolling is clockwise or counterclockwise.

In addition to the problem of having a different operation depending on the vehicle curving to one side or the other, the adjustment of the damping is extremely complex and without guarantees of ensuring that they do not increase the unequal behavior depending on the direction of rolling.

With our system the shock absorber starts to work independently of the direction of the rolling, that is, whether the rolling happens in the clockwise direction or contrary to the clockwise, the increase in rolling always happens in the compression phase of the roll damper and the reduction of the rolling (returning to the initial position) always happens in the expansion phase of the damper.

In addition to guaranteeing a symmetry of behavior in the two rolling directions, we managed to make it possible to regulate the rolling's damping easily and with guarantees that we only affect the behavior we want (damping of the rolling increase or rolling decrease).

The present disclosure is advantageous, in particular, for:
Independently control the symmetrical movements of an axis with the asymmetric movements of an axis;
Independently control the damping of the increased rolling angle or the decrease of the rolling angle;
Ensure that the suspension work perfectly symmetrically;
Decrease the number of parts of the complete suspension, its weight and the occupied volume;
A suspension system that is easily operated in maintenance and easy to adjust or tuning.

It is disclosed a roll damper assembly for a vehicle suspension, comprising: a first bracket comprising a first inner bracket and a first outer bracket; a second bracket comprising a second inner bracket and a second outer bracket; a roll damper mounted between the first inner bracket and the second inner bracket; a first mount coupled to the first outer bracket and a second mount coupled to the second outer bracket, for mounting the roll damper assembly to the vehicle suspension; a first guide rod attached at a first end to the first outer bracket, and slidably attached to the inner second bracket for traversing the inner second bracket at a second end of the first guide rod; a second guide rod attached at a first end to the second outer bracket, and slidably attached to the inner first bracket for traversing the inner first bracket at a second end of the second guide rod; a first end stopper mounted on the second end of said first guide rod to stop the second end of said first guide rod from exiting from the slidable attachment to the inner second bracket; a second end stopper mounted on the second end of said second guide rod to stop the second end of said second guide rod from exiting from the slidable attachment to the inner first bracket.

In an embodiment, the roll damper assembly further comprises a first rocker arm coupled to the first mount and a second rocker arm coupled to the second mount for incorporating the roll damper assembly to the vehicle suspension.

In an embodiment, the roll damper assembly further comprises a heave damper mounted between said first and second rockers.

In an embodiment, the roll damper assembly further comprises two roll damper couplings mounted between the inner first and second brackets to receive the roll damper.

In an embodiment, the roll damper assembly comprises a third guide rod attached at the first end to the first outer bracket, and slidably attached to the inner second bracket for traversing the inner second bracket at a second end of the first guide rod; a fourth guide rod attached at the first end to the second outer bracket, and slidably attached to the inner first bracket for traversing the inner first bracket at a second end of the second guide rod; a third end stopper mounted on the second end of said first guide rod to stop the second end of said first guide rod from exiting from the slidable attachment to the inner second bracket; a fourth end stopper mounted on the second end of said second guide rod to stop the second end of said second guide rod from exiting from the slidable attachment to the inner first bracket.

It is also disclosed a vehicle suspension comprising one or more roll damper assemblies according to any of the previous embodiments.

It is also disclosed a vehicle comprising a vehicle suspension according to the previous embodiment.

It is also disclosed a mounting method of a roll damper assembly according to any of the previous embodiments comprising: mounting the roll damper assembly to the vehicle suspension by the first and second mounts; assembling the roll damper by bolting the damper to the inner brackets, while the spring is loose on the damper.

In an embodiment, the spring is adjusted to have no preload.

In an embodiment, the step of assembling of a heave damper by bolting said heave damper to said first and second rockers, while a spring of said heave damper is loose on the damper.

In an embodiment, the assembling of the heave damper is made after the roll damper is assembled.

In an embodiment, the spring of said heave damper is adjusted to have no preload.

It is also disclosed a manufacturing method of a roll damper assembly for a vehicle suspension, comprising: providing a first bracket comprising a first inner bracket and a first outer bracket; providing a second bracket comprising a second inner bracket and a second outer bracket; mounting a roll damper mounted between the first inner bracket and the second inner bracket; mounting a first mount coupled to the first outer bracket and a second mount coupled to the second outer bracket, for mounting the roll damper assembly to the vehicle suspension; attaching a first guide rod at a first end to the first outer bracket, and slidably attached to the inner second bracket for traversing the inner second bracket at a second end of the first guide rod; attaching a second guide rod at a first end to the second outer bracket, and slidably attached to the inner first bracket for traversing the inner first bracket at a second end of the second guide rod; mounting a first end stopper on the second end of said first guide rod to stop the second end of said first guide rod from exiting from the slidable attachment to the inner second bracket; mounting a second end stopper on the second end of said second guide rod to stop the second end of said second guide rod from exiting from the slidable attachment to the inner first bracket.

In an embodiment, the manufacturing method further comprising coupling a first rocker arm to the first mount and a second rocker arm coupled to the second mount for incorporating the roll damper assembly to the vehicle suspension.

In an embodiment, the manufacturing method further comprising mounting a heave damper between said first and second rockers.

### BRIEF DESCRIPTION OF THE DRAWINGS

The following figures provide preferred embodiments for illustrating the disclosure and should not be seen as limiting the scope of invention.

FIG. 1: Schematic representation of an embodiment of a suspension system.

FIG. 2: Schematic representation of an embodiment of a conventional suspension system.

FIG. 3: Schematic representation of an embodiment of a suspension system with the disclosed rolling damper.

FIG. 4: Schematic representation of an embodiment of a suspension system with the disclosed rolling damper, where:
(1) represents a first suspension rocker;
(2) represents a second suspension rocker;
(3) represents a first mounting bracket;
(4) represents linear guide rods;
(5) represents a damper mounting bracket;
(6) represents an end stop cap;
(7) represents a lower mounting point for the roll damper;
(8) represents a second mounting bracket;
(9) represents a heave damper mounting bracket;
(10) represents a heave damper;
(11) represents a rolling damper.

FIG. 5: Schematic representation of an embodiment of a suspension system with the disclosed rolling damper with visible springs.

FIG. 6: Schematic representation of an embodiment of a suspension system with the disclosed rolling damper.

FIG. 7: Schematic representation of an embodiment of a suspension system with the disclosed rolling damper.

FIG. 8: Schematic representation of an embodiment of a suspension system, where:
(A) represents a perspective view of the assembly;
(B) represents an end view of the assembly;
(C) represents a lateral view of the assembly;
(D) represents a top view of the assembly.

FIG. 9: Schematic representation of an embodiment of a suspension system, where:
(3) represents a first bracket;
(3a) represents a first inner bracket;
(3b) represents a first outer bracket;
(4a) represents a first guide rod;
(4b) represents a second guide rod;
(6a) represents a first end stopper;
(6b) represents a second end stopper;
(7) represents a second rocker arm;
(8) represents a second bracket;
(8a) represents a second inner bracket;
(8b) represents a second outer bracket;
(11) represents a roll damper;
(12) represents a roll damper coupling;
(13) represents a first rocker arm.

FIG. 10: Schematic representation of an embodiment of a suspension system, where:
(a) represents a traditional movement with a hysteresis between motion in compression (bump) and expansion (rebound) and the force that results from that movement for compressing.
(b) represents a traditional movement with a hysteresis between motion in compression (bump) and expansion (rebound) and the force that results from that movement for dropping.
(c) represents a movement of the present discloses with a hysteresis between motion in compression (bump) and expansion (rebound) and the force that results from that movement for dropping.
(d) represents a movement of the present discloses with a hysteresis between motion in compression (bump) and expansion (rebound) and the force that results from that movement for compressing.

### DETAILED DESCRIPTION

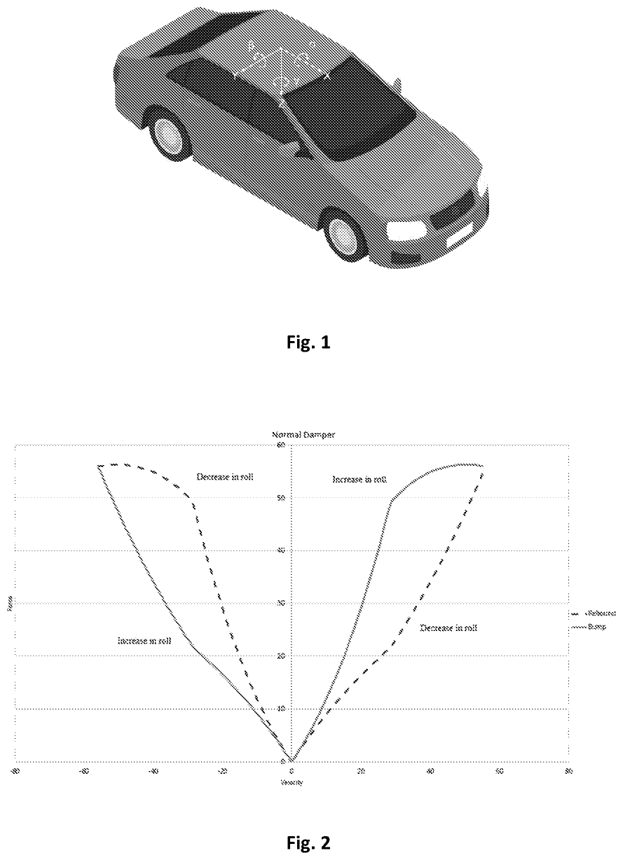

FIG. 1 shows a schematic representation of an embodiment of a suspension system. The suspension system of the present discloses can work with the rolling/asymmetric movement separately from the vertical/symmetrical movement of the automobile. This discloses is a rolling damper only with two dampers where one damper the Vertical/Symmetrical movement and the other, through an innovative mechanical system, manages to absorb the asymmetric movement in compression, when the car tilts and expanding when the car returns.

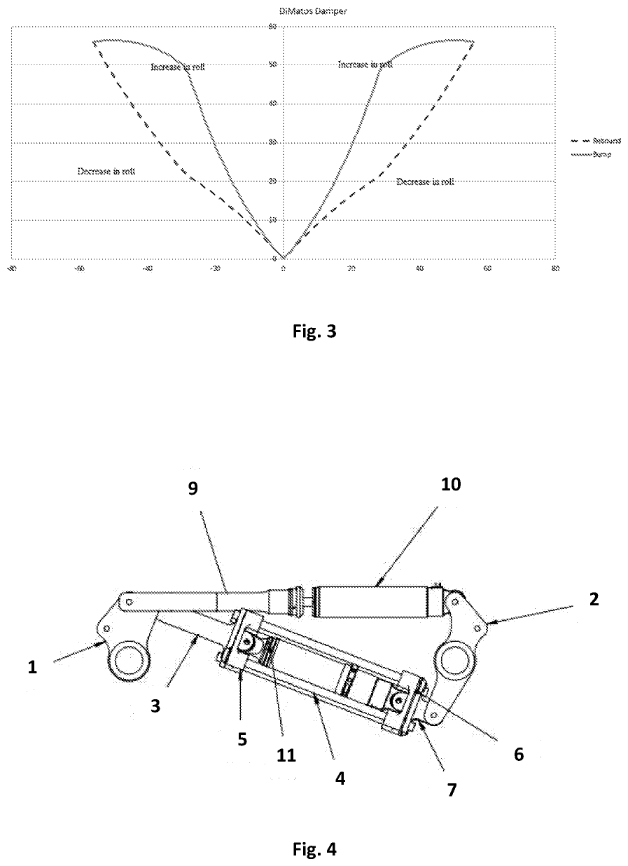

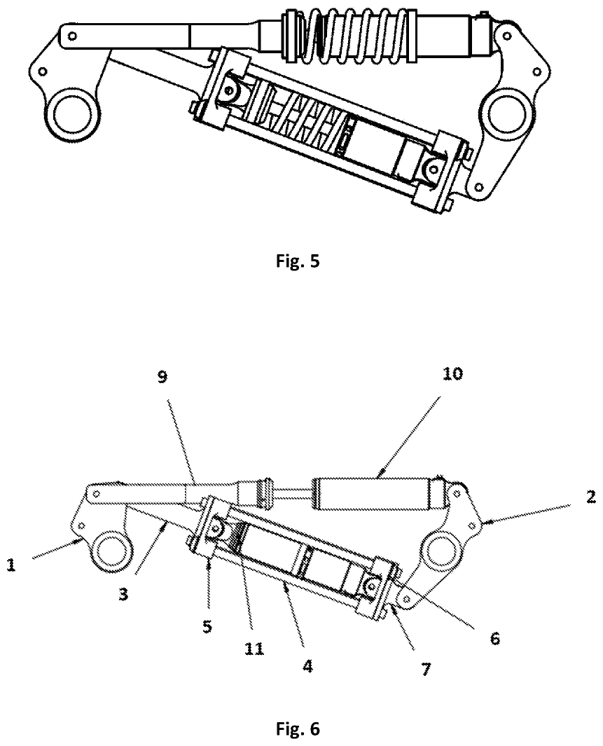

FIG. 2 shows a schematic representation of an embodiment of a conventional suspension system. FIG. 3 shows a schematic representation of an embodiment of suspension system with the disclosed rolling damper.

FIG. 4 shows a schematic representation a roll damper assembly for a vehicle suspension where 5 represents a first bracket comprising a first inner bracket and a first outer bracket; 6 represents a second bracket comprising a second inner bracket and a second outer bracket; 11 represents a roll damper mounted between the first inner bracket and the second inner bracket; 3 represents a first mount coupled to the first outer bracket and 7 represents a second mount coupled to the second outer bracket, for mounting the roll damper assembly to the vehicle suspension; 4 represents a first guide rod attached at a first end to the first outer bracket, and slidably attached to the inner second bracket for traversing the inner second bracket at a second end of the first guide rod

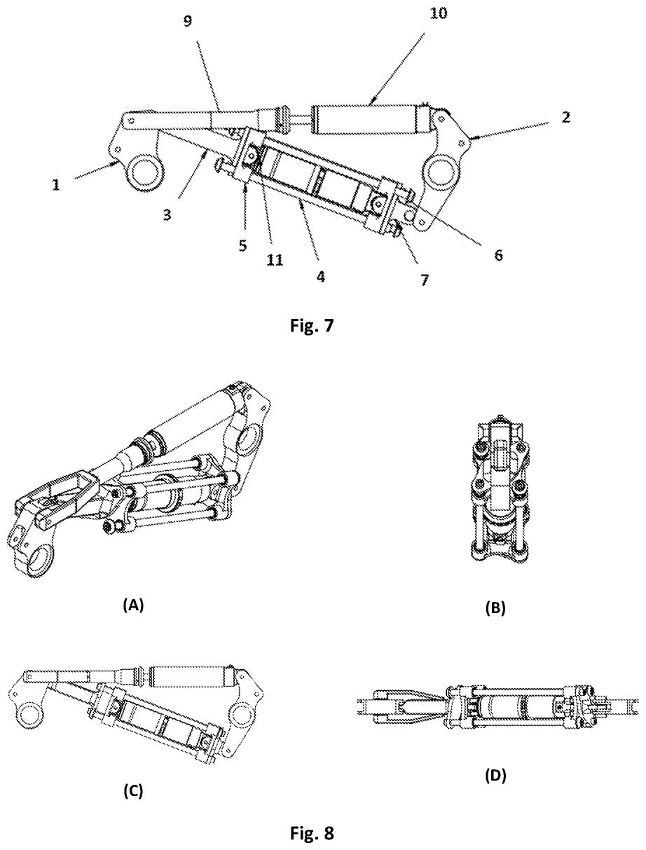

FIG. 5 shows a schematic representation a suspension system with the disclosed rolling damper with visible springs.

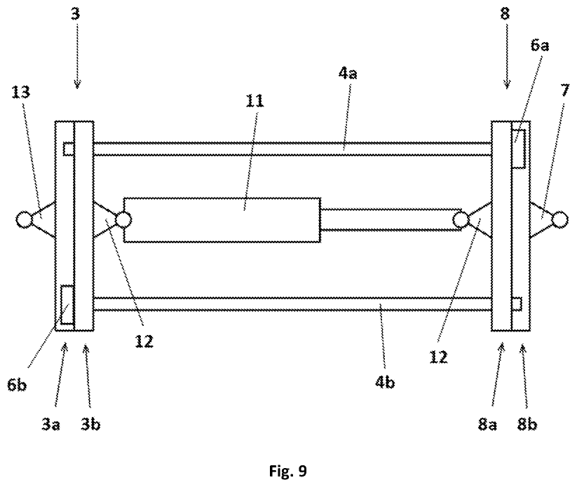

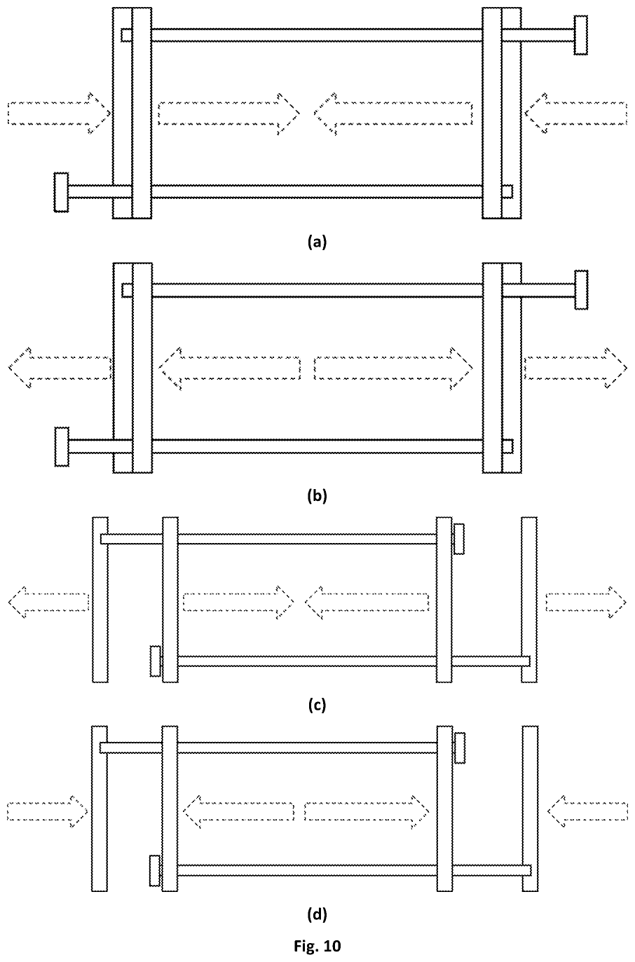

FIGS. 6 and 7 shows a schematic representation a suspension system with the disclosed rolling damper.

FIG. 8 shows a schematic representation of a suspension system, where: (A) represents a perspective view of the assembly; (B) represents an end view of the assembly; (C) represents a lateral view of the assembly; (D) represents a top view of the assembly.

FIG. 9 shows a schematic representation of an embodiment of a suspension system, where: 3 represents a first bracket; 3a represents a first inner bracket; 3b represents a first outer bracket; 4a represents a first guide rod; 4b represents a second guide rod; 6a represents a first end stopper; 6b represents a second end stopper; 7 represents a second rocker arm; 8 represents a second bracket; 8a represents a second inner bracket; 8b represents a second outer bracket; 11 represents a roll damper; 12 represents a roll damper coupling; 13 represents a first rocker arm.

FIG. 10 shows a schematic representation of a suspension system, where: (a) represents a traditional movement with a hysteresis between motion in compression (bump) and expansion (rebound) and the force that results from that movement for compressing; (b) represents a traditional movement with a hysteresis between motion in compression (bump) and expansion (rebound) and the force that results from that movement for dropping; (c) represents a movement of the present discloses with a hysteresis between motion in compression (bump) and expansion (rebound) and the force that results from that movement for dropping; (d) represents a movement of the present discloses with a hysteresis between motion in compression (bump) and expansion (rebound) and the force that results from that movement for compressing.

The term “comprising” whenever used in this document is intended to indicate the presence of stated features, integers, steps, components, but not to preclude the presence or addition of one or more other features, integers, steps, components or groups thereof. The disclosure should not be seen in any way restricted to the embodiments described and a person with ordinary skill in the art will foresee many possibilities to modifications thereof. The above-described embodiments are combinable. The following claims further set out particular embodiments of the disclosure.

1. A roll damper assembly for a vehicle suspension, comprising:
a first bracket comprising a first inner bracket and a first outer bracket;
a second bracket comprising a second inner bracket and a second outer bracket;
a roll damper mounted between the first inner bracket and the second inner bracket;
a first mount coupled to the first outer bracket and a second mount coupled to the second outer bracket, the first and second mounts configured to mount the roll damper assembly to the vehicle suspension;
a first guide rod attached at a first end to the first outer bracket and slidably attached to the inner second bracket and configured to traverse the inner second bracket at a second end of the first guide rod;
a second guide rod attached at a first end to the second outer bracket and slidably attached to the inner first bracket and configured to traverse the inner first bracket at a second end of the second guide rod;
a first end stopper mounted on the second end of said first guide rod to stop the second end of said first guide rod from exiting from the slidable attachment to the inner second bracket; and
a second end stopper mounted on the second end of said second guide rod to stop the second end of said second guide rod from exiting from the slidable attachment to the inner first bracket.

2. The roll damper assembly according to claim 1, further comprising a first rocker arm coupled to the first mount and a second rocker arm coupled to the second mount, wherein the first and second rocker arms are configured to incorporate the roll damper assembly to the vehicle suspension.

3. The roll damper assembly according to claim 2, further comprising a heave damper mounted between said first and second rockers.

4. The roll damper assembly according to claim 1, further comprising two roll damper couplings mounted between the inner first and second brackets to receive the roll damper.

5. The roll damper assembly according to claim 1, further comprising:
a third guide rod attached at the first end to the first outer bracket, and slidably attached to the inner second bracket and configured to traverse the inner second bracket at a second end of the first guide rod;
a fourth guide rod attached at the first end to the second outer bracket, and slidably attached to the inner first bracket for traversing the inner first bracket at a second end of the second guide rod;
a third end stopper mounted on the second end of said first guide rod to stop the second end of said first guide rod from exiting from the slidable attachment to the inner second bracket; and
a fourth end stopper mounted on the second end of said second guide rod to stop the second end of said second guide rod from exiting from the slidable attachment to the inner first bracket.

6. (canceled)

7. (canceled)

8. A mounting method roll damper assembly according to claim 1, further comprising:
mounting the roll damper assembly to the vehicle suspension by the first and second mounts; and
assembling the roll damper by bolting the damper to the inner brackets while the spring is loose on the damper.

9. The mounting method according to claim 8, including the step of adjusting the spring to have no preload.

10. The mounting method according to claim 8, wherein the roll damper assembly further comprises a first rocker arm coupled to the first mount and a second rocker arm coupled to the second mount, wherein the first and second rocker arms are configured to incorporate the roll damper assembly to the vehicle suspension, further comprising the step of assembling heave damper by bolting said heave damper to said first and second rockers, while a spring of said heave damper is loose on the damper.

11. The mounting method according to claim 10, wherein assembling of the heave damper is performed after the roll damper is assembled.

12. The mounting method according to claim 8, further comprising the step of adjusting the spring of said heave damper to have no preload.

13. A manufacturing method of a roll damper assembly for a vehicle suspension, comprising:
providing a first bracket comprising a first inner bracket and a first outer bracket;
providing a second bracket comprising a second inner bracket and a second outer bracket;
mounting a roll damper mounted between the first inner bracket and the second inner bracket;
mounting a first mount coupled to the first outer bracket and a second mount coupled to the second outer bracket, wherein the first and second mounts are configured to mount the roll damper assembly to the vehicle suspension;
attaching a first guide rod at a first end to the first outer bracket and slidably attaching to the inner second bracket in order to traverse the inner second bracket at a second end of the first guide rod;
attaching a second guide rod at a first end to the second outer bracket and slidably attaching to the inner first bracket in order to traverse the inner first bracket at a second end of the second guide rod;
mounting a first end stopper on the second end of said first guide rod to stop the second end of said first guide rod from exiting from the slidable attachment to the inner second bracket; and
mounting a second end stopper on the second end of said second guide rod to stop the second end of said second guide rod from exiting from the slidable attachment to the inner first bracket.

14. The manufacturing method according to claim 13, the method further comprising coupling a first rocker arm to the first mount and a second rocker arm coupled to the second mount in order to incorporate the roll damper assembly to the vehicle suspension.

15. The manufacturing method according to claim 14, further comprising mounting a heave damper between said first and second rockers.
